(19) United States
(12) Patent Application Publication
(10) Pub. No.: US 2014/0228113 A1
(43) Pub. Date: Aug. 14, 2014

(54) SYSTEM FOR PROVIDING PLATFORM CAPABLE OF PROVIDING PLURALITY OF SERVICES

(71) Applicant: DeNA Co., Ltd., Tokyo (JP)

(72) Inventors: Hotaka KAWADA, Tokyo (JP); Naoto YOSHIE, Tokyo (JP); Takashi NINJOUJI, Tokyo (JP)

(73) Assignee: DeNA Co., Ltd., Tokyo (JP)

(21) Appl. No.: 14/163,881

(22) Filed: Jan. 24, 2014

(30) Foreign Application Priority Data
Feb. 8, 2013 (JP) 2013-022933

(51) Int. Cl. G06F 9/44; A63F 13/00

(52) U.S. Cl. CPC G06F 9/4446; A63F 13/00
USPC 463/31; 715/708

(57) ABSTRACT

One object of the present invention is to guide a user to various services provided by a platform effectively. The system according to an embodiment includes: a service provision control unit for controlling provision of services; an information storage unit for storing information; a determination unit for determining whether a user operating a terminal device owns a particular game content and comparing the activity points in the game played by the user with a predetermined threshold value; a decision unit for deciding a display mode of a guidance display screen displaying a guidance display area for guiding the user to a service-providing screen for providing a particular service based on a determination result produced by the determination unit and a display control unit for sending, to the terminal device, screen data of the guidance display screen to be displayed in accordance with the display mode decided by the decision unit.

### CROSS-REFERENCE TO RELATED APPLICATIONS

This application is based on and claims the benefit of priority from Japanese Patent Application Serial No. 2013-022933 (filed on Feb. 8, 2013), the contents of which are hereby incorporated by reference in their entirety.

### TECHNICAL FIELD

The present invention relates to a system and a method using the system. More specifically, the system is connected via a communication network to a plurality of terminal devices operated by users and provides a platform capable of providing a plurality of services to the users.

### BACKGROUND

Conventionally known such systems include a system for providing a platform capable of providing services such as various games and social networking services (SNS) via a network such as the Internet to terminal devices such as smartphones, tablet terminals, personal computers, or game-dedicated terminals. Services provided by such systems use virtual electronic contents such as cards and items; and users obtain such electronic contents and use the services with the obtained electronic contents (see, e.g., Japanese Patent Application Publication No. 2002-282534). For electronic contents used for games (game contents), various cards having different attributes and parameters such as rarity are prepared to enhance playability; and users can advantageously progress the game with these cards.

Unfortunately, it is not easy for, e.g., novice game users to use these various game contents effectively. As a result, a user owning a useful game content may miss the chance to make a good use of the game content. Such a problem also occurs for electronic contents used in services other than games; therefore, there is a need for a setup in which a user owning a useful electronic content is effectively guided to related services.

### SUMMARY

One object of the present invention is to guide a user to various services provided by a platform more effectively. Other objects of the present disclosure will be apparent with reference to the entire description in this specification.

A system according to an embodiment of the present invention is a system connected via a communication network to a plurality of terminal devices each operated by a user, the system being configured to provide a platform capable of providing a plurality of services to the user, the system comprising: an information storage device configured to store, for each user, owned electronic content information on one or more electronic contents owned by the user and used in the services; and one or more processors capable of executing a program, wherein the program comprises: a determination module configured to determine, in response to a request from one of the terminal devices, whether the user operating the terminal device owns a particular electronic content based on the owned electronic content information; a decision module configured to decide, based at least on a comparison result made by the determination module, a display mode of a guidance display screen capable of displaying a guidance display area for guiding the user to a service-providing screen used for providing a particular service, the guidance display screen being used for providing the platform or a service other than the particular service; and a display control module configured to cause the terminal device to display the guidance display screen in the decided display mode. The “services” above include, e.g., various games, SNS, music distribution, and call/message exchange but are not limited thereto. Further, “electronic contents” include various electronic contents used in the services, the examples of which include cards, items, virtual currency, digital incentive, and stamp, but are not limited thereto.

A system according to an embodiment of the present invention is a system connected via a communication network to a plurality of terminal devices each operated by a user, the system being configured to provide a platform capable of providing a plurality of services to the user, the system comprising: an information storage unit configured to store, for each user, owned electronic content information on one or more electronic contents owned by the user and used in the services; a determination unit configured to determine, in response to a request from the terminal device, whether the user operating the terminal device owns a particular electronic content based on the owned electronic content information; a decision unit configured to decide, based at least on a comparison result made by the determination unit, a display mode of a guidance display screen capable of displaying a guidance display area for guiding the user to a service-providing screen used for providing a particular service, the guidance display screen being used for providing the platform or a service other than the particular service; and a display control unit configured to cause the terminal device to display the guidance display screen in the decided display mode.

A method according to an embodiment of the present invention is a method using a system for providing a platform capable of providing a plurality of services to a plurality of users each operating a terminal device connected to the system via a communication network, the method comprising the steps of: storing, for each user, owned electronic content information on one or more electronic contents owned by the user and used in the services; determining, in response to a request from the terminal device, whether the user operating the terminal device owns a particular electronic content based on the owned electronic content information; deciding, based at least on a result of the comparison, a display mode of a guidance display screen capable of displaying a guidance display area for guiding the user to a service-providing screen used for providing a particular service, the guidance display screen being used for providing the platform or a service other than the particular service; and causing the terminal device to display the guidance display screen in the decided display mode.

Various embodiments of the present invention enable guiding a user to various services provided by a platform more effectively.

### BRIEF DESCRIPTION OF THE DRAWINGS

FIG. 1 is a block diagram schematically illustrating a network configuration including a system according to an embodiment of the present invention.

FIG. 2 is a block diagram schematically illustrating the architecture of a terminal device according to an embodiment.

FIG. 3 is a block diagram illustrating the functionality of the system according to an embodiment.

FIG. 4 is a diagram showing a specific example of a game content management table according to an embodiment.

FIG. 5 is a diagram showing a specific example of an owned game content management table according to an embodiment.

FIG. 6 is a diagram showing a specific example of an activity point management table according to an embodiment.

FIG. 7 is a flow diagram showing an example of a first guidance display screen-displaying process according to an embodiment.

FIG. 8 is a diagram showing an example of an activity point deficiency screen according to an embodiment.

FIG. 9 is a diagram showing an example of an activity point deficiency screen according to an embodiment.

FIG. 10 is a diagram showing an example of My Menu screen according to an embodiment.

FIG. 11 is a diagram showing an example of My Menu screen according to an embodiment.

FIG. 12 is a diagram showing an example of My Game screen according to an embodiment.

FIG. 13 is a diagram showing an example of Music Service My Menu screen according to an embodiment.

### DESCRIPTION OF EXAMPLE EMBODIMENTS

Various embodiments of the present invention will be described hereinafter with reference to the drawings. In the drawings, the same components are denoted by the same reference numerals.

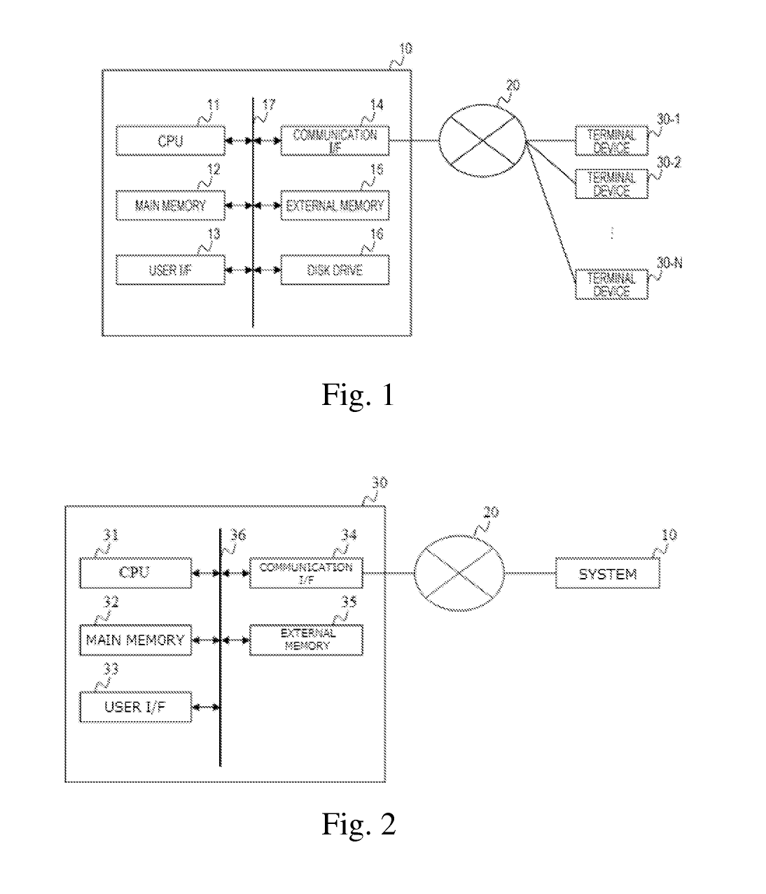

FIG. 1 is a block diagram schematically illustrating a network configuration including a system 10 according to an embodiment of the present invention. As illustrated in FIG. 1, the system 10 according to an embodiment may be communicatively connected to a plurality of terminal devices 30-1, 30-2, . . . , and 30-N (hereinafter also collectively referred to as the “terminal devices 30”), each having a communication function, via a communication network 20 such as the Internet. The server device 10 may provide users operating the terminal devices 30 with a platform capable of providing various services such as various games, SNS, music distribution, and call/message exchange.

As illustrated in FIG. 1, the system 10 according to an embodiment may include a central processing unit (CPU) (processor) 11, a main memory 12, a user interface (I/F) 13, a communication I/F 14, an external memory 15, and a disk drive 16, and these components may be electrically connected to one another via a bus 17. The CPU 11 may load an operating system and various programs into the main memory 12 from the external memory 15, and may execute commands included in the loaded programs. The main memory 12 may be used to store a program to be executed by the CPU 11, and may be formed of, for example, a dynamic random access memory (DRAM).

The user I/F 13 may include, for example, an information input device such as a keyboard or a mouse for accepting an input from an operator, and an information output device such as a liquid crystal display for outputting calculation results of the CPU 11. The communication I/F 14 may be implemented as hardware, firmware, or communication software such as a transmission control protocol/Internet protocol (TCP/IP) driver or a point-to-point protocol (PPP) driver, or a combination thereof, and may be configured to be able to communicate with the terminal devices 30 via the communication network 20.

The external memory 15 may be formed of, for example, a magnetic disk drive and store a control program for controlling provision of various services such as games. The external memory 15 may also store various data used in the various services. The various data that may be stored in the external memory 15 may also be stored on a database server communicatively connected to the system 10 and physically separate from the system 10. The disk drive 16 may read data stored in a storage medium such as a compact disc read only memory (CD-ROM), digital versatile disc read only memory (DVD-ROM), or DVD Recordable (DVD-R) disc, or write data to such a storage medium. For example, applications stored in a storage medium and various data for use in the various services may be read by the disk drive 16, and may be installed into the external memory 15.

In an embodiment, the system 10 may be a web server for managing a web site including a plurality of hierarchical web pages and may be capable of providing the terminal devices 30 with various services such as various games, SNS, music distribution, and call/message exchange. The terminal devices 30 may fetch HTML data for rendering a web page from the system 10 and analyze the fetched HTML data to present the web page to a user of the terminal devices 30. A game provided through such a web page is sometimes called a browser game. The HTML data for rendering the web page may also be stored on the external memory 15. The HTML data may comprise HTML documents written in markup languages such as HTML; the HTML documents may be associated with various images. Additionally, the HTML documents may include programs written in script languages such as ActionScript™ and JavaScript™.

The external memory 15 may store applications to be executed on execution environments of the terminal device 30 other than browser software. These applications may include programs for receiving services and various data such as image data to be referred to for executing the programs. The programs may be created in, for example, object oriented languages such as Objective-C™ and Java™. The created programs may be stored on the external memory 15 in the form of application software along with various data. The application software stored on the external memory 15 may be delivered to a terminal device 30 in response to a delivery request. The application software delivered from the system 10 may be received by the terminal device 30 through a communication I/F 34 in accordance with the control of CPU 31; the received programs may be sent to an external memory 35 and stored thereon. The application software may be launched in accordance with the user's operation on the terminal device 30 and may be executed on an execution environment implemented on the terminal device 30 such as NgCore™ or Android™. The system 10 may provide the applications executed on the terminal devices 30 with various data required for providing services. Additionally, the system 10 can store various data sent from the terminal device 30 for each user, thereby managing the state of provided services (e.g., the progression of the game) for each user.

Thus, the system 10 may manage the web site for providing various services and deliver web pages constituting the web site in response to a request from the terminal device 30, thereby providing a service to a user. Also, the system 10 can provide services based on communication with an application performed on the terminal device 30 in place of, or in addition to, such browser-based services. Whichever mode may be taken to provide the services, the system 10 can store data required to provide the services for each identification identifying a user. Briefly, the system 10 may also include a function to authenticate a user at start of provision of services and perform charging process in accordance with provision of services. The games provided by the system 10 may include desired games such as action games, role playing games, interactive baseball games, and card games. The types of the games implemented by the system 10 are not limited to those explicitly disclosed herein.

In an embodiment, the terminal device 30 may be any information processing device that may display on a web browser a web page of a web site for providing services obtained from the system 10 and include an executing environment for executing applications.

The architecture of the terminal device 30 will now be described with reference to FIG. 2. FIG. 2 is a block diagram schematically illustrating the architecture of a terminal device 30. As illustrated in FIG. 2, the terminal device 30 may include a central processing unit (CPU) 31, a main memory 32, a user interface (I/F) 33, a communication I/F 34, and an external memory 35, and these components may be electrically connected to one another via a bus 36.

The CPU 31 may load various programs such as an operating system into the main memory 32 from the external memory 35, and may execute commands included in the loaded programs. The main memory 32 may be used to store a program to be executed by the CPU 31, and may be formed of, for example, a dynamic random access memory (DRAM).

The user I/F 33 may include, for example, an information input device such as a touch panel, a keyboard, a button, and a mouse for accepting an input from a user, and an information output device such as a liquid crystal display for outputting calculation results of the CPU 31. The communication I/F 34 may be implemented as hardware, firmware, or communication software such as a transmission control protocol/Internet protocol (TCP/IP) driver or a point-to-point protocol (PPP) driver, or a combination thereof, and may be configured to be able to communicate with the system 10 via the communication network 20.

The external memory 35 may comprise, for example, a magnetic disk drive or a flash memory and store various programs such as an operating system. When receiving an application from a system 10 via the communication I/F 34, the external memory 35 may store the received application.

A terminal device 30 having such an architecture may include, for example, browser software for interpreting an HTML file (HTML data) and rendering a screen; this browser software may enable the terminal device 30 to interpret the HTML data fetched from the system 10 and render web pages corresponding to the received HTML data. Further, the terminal device 30 may include plug-in software (e.g., Flash Player distributed by Adobe Systems Incorporated) embedded into browser software; therefore, the terminal device 30 can fetch from the system 10 a SWF file embedded in HTML data and execute the SWF file by using the browser software and the plug-in software.

When a service is received on the terminal device 30, for example, animation or an operation icon designated by the program may be displayed on a screen of the terminal device 30. The user may enter an instruction for receiving the service using an input interface of the terminal device 30. The instruction entered by the user may be transmitted to the system 10 through the browser of the terminal device 30 or a function of an execution environment such as NgCore™.

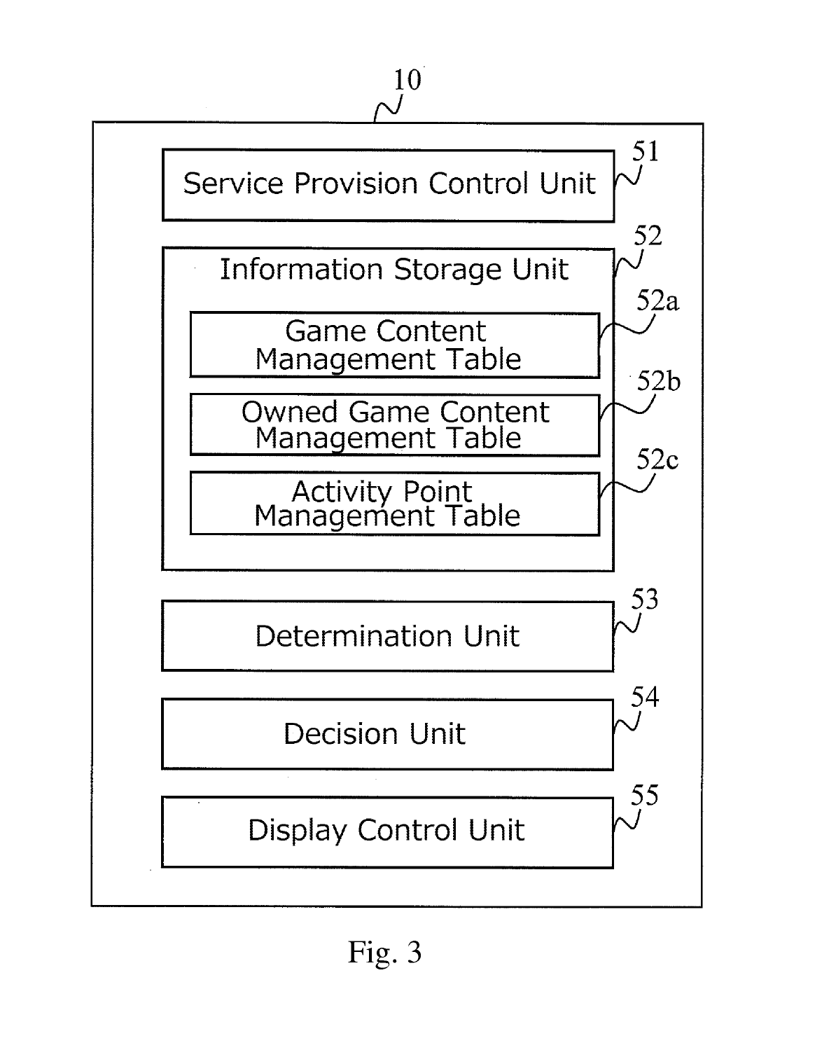

Next, the functionality of the system 10 implemented by the components shown in FIG. 1 will now be described. As described above, the system 10, which can provide various services, will now be described with a focus on functions related to various games. Games are examples suitable for description of an embodiment of the present invention. FIG. 3 is a block diagram illustrating the functionality of a system 10 according to an embodiment of the present invention. As shown, the system 10 comprises: a service provision control unit 51 for controlling provision of services such as progression of a game; an information storage unit 52 for storing information; a determination unit 53 for determining whether a user operating a terminal device 30 owns a particular game content and comparing the activity points in the game played by the user with a predetermined threshold value; a decision unit 54 for deciding a display mode of a guidance display screen that displays a guidance display area for guiding the user to a service-providing screen used to provide a particular service based on a determination result produced by the determination unit 53; and a display control unit 55 for sending, to the terminal device 30, screen data of the guidance display screen to be displayed in accordance with the display mode decided by the decision unit 54. These functions may be implemented through cooperation between the CPU 11 of the system 10 and various programs and tables stored in the main memory 12 and the external memory 15, wherein, for example, the CPU 11 may perform a program including at least modules corresponding to the functions of the determination unit 53, decision unit 54, and display control unit 55.

The service provision control unit 51 may send and receive various data required for providing services such as the progression of various games to and from the terminal device 30 and manage such data for each user, thereby controlling provision of the services for each user. For example, the service provision control unit 51 can sequentially display, on the terminal device 30, web pages constituting a web site for providing services in response to a request from the terminal device 30. When a hyperlink on the displayed web page is selected by the user, the service provision control unit 51 may send new HTML data corresponding to the hyperlink to the terminal device 30. The terminal device 30 may display a web page based on the new HTML data. Thus, the service provision control unit 51 may control the service such that web pages stored on the system 10 are sequentially provided to the terminal device 30 in accordance with the operation by the user; and the user can receive the service, or progress the game for example, by his own operation through the function of the service provision control unit 51. Additionally, the service provision control unit 51 and the display control unit 55 may cooperate with each other to control the display of the above-mentioned guidance display screen on the terminal device 30.

When the terminal device 30 executes the game application, the service provision control unit 51 can send various data used in the game to the game application. For example, when receiving from a game application on the terminal device 30 a control signal indicating that a certain mission has been cleared, the service provision control unit 51 may provide the game application with various parameters related to a mission subsequent to the cleared mission. The game application may load the data provided by the system 10 and progress the game.

The terminal device 30 can appropriately send to the system 10 various information on progression of the game such as information indicating various parameter values used in the game (information on earned game points and earned items) and information indicating a status (information specifying a fulfilled mission), through the function of browser software or the game application. The service provision control unit 51 may store, for each user, information on the progression of the game received from a plurality of terminal devices 30, thereby controlling the progression of the game for each user. Thus, when the user logs in the system 10 using his own ID, the game may be resumed from the stage corresponding to the progression of the user (e.g., the stage where the game was interrupted) based on the information on the progression of the game associated with the user and stored in the system 10. The information required for the progression of the game may also be managed by various functions of the system 10 other than the service provision control unit 51.

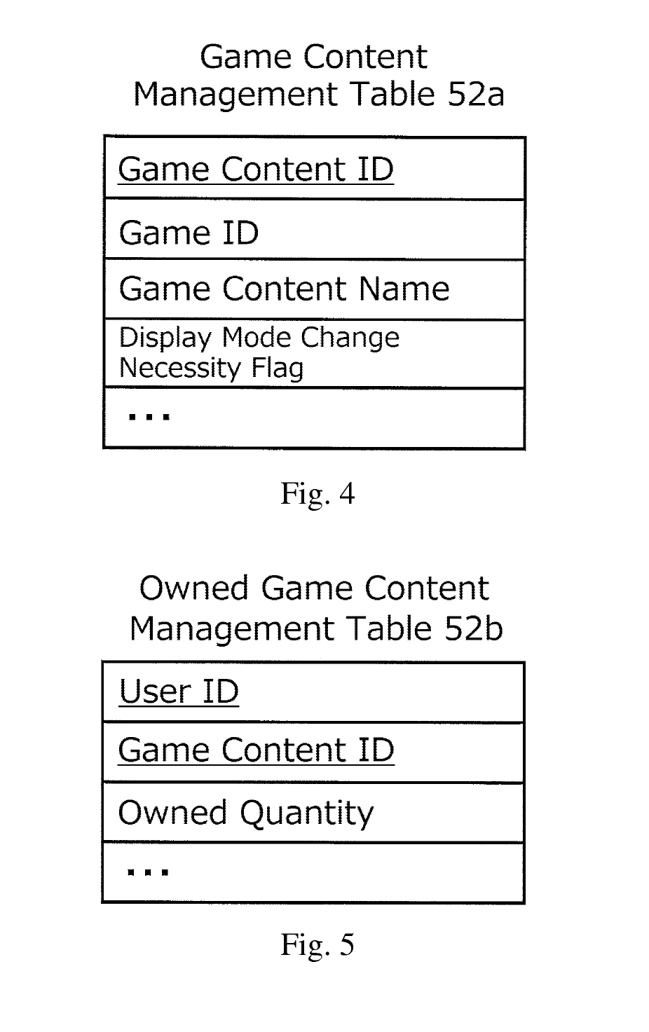

The information storage unit 52 may comprise: a game content management table 52a for managing information on game contents used in the games; an owned game content management table 52b for managing information on game contents owned by the user; and an activity point management table 52c for managing activity points in the games played by the user. FIG. 4 shows an example of information managed by the game content management table 52a. As shown, the game content management table 52a may manage, in association with “game content ID” identifying a game content such as a card or an item, information such as “game ID” identifying the game in which the game content is used, “game content name” of the game content, and “display mode change necessity flag” indicating whether it is necessary to change the display mode of the guidance display area when the user owns the game content. Additionally, the necessity of change in display mode of the guidance display area may also be determined based on information other than “display mode change necessity flag.” For example, the game content management table 52a may manage “rarity” indicating the rarity of a game content; and when the rarity is a particular value (e.g., “Ultra Rare” (UR)), it may be determined that the display mode of the guidance display area has to be changed; and when the rarity is another value (e.g., “Common” (C), “Uncommon” (UC), “Rare” (R), or “Super Rare” (SR)), it may be determined that the display mode of the guidance display area does not have to be changed. The game content management table 52a may manage information on game contents including various parameters and attributes such as ability values, in addition to the above examples of information. The game content management table 52a in this example may manage information on game contents for each of all the plurality of games provided by the system 10; alternatively, it may also be possible that each different table should manage information on game contents for only a corresponding game.

FIG. 5 shows an example of information managed by the owned game content management table 52b. As shown, the owned game content management table 52b may manage information such as “owned quantity” indicating the number of game contents owned by a user, in association with a combination of a “user ID” identifying the user and a “game content ID” identifying the game contents. In an embodiment, a user can obtain game contents at various opportunity; for example, a game content may be obtained by progressing a mission, performing a lottery (gasha), winning a battle with another user, exchanging (trading) game contents with another user, and receiving the game content as a present from another user. When a game content is thus obtained or used (consumed), the service provision control unit 51 may update the information in the owned game content management table 52b. The owned game content management table 52b in this example may manage quantities of game contents owned by the user for each of all the plurality of games provided by the system 10; alternatively, it may also be possible that each different table should manage quantities of game contents owned by the user for only a corresponding game.

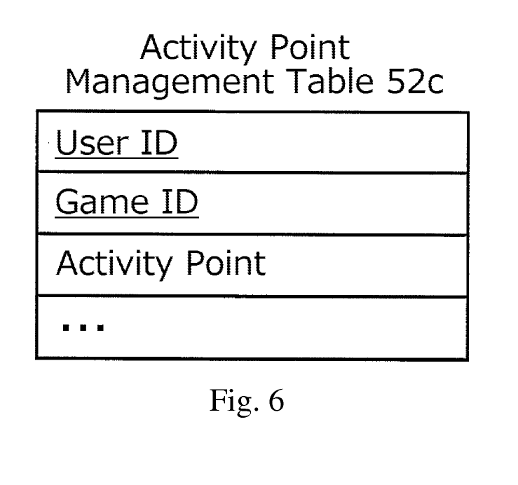

FIG. 6 shows an example of information managed by the activity point management table 52c. As shown, the activity point management table 52c may manage information such as “activity points” indicating the current value of activity points of a user in a game, in association with a combination of a “user ID” identifying the user and a “game ID” identifying the game. The “activity points” may be a parameter that may reduce upon predetermined actions in the games (e.g., advancement in a mission and a battle with an enemy character) and increase (recover) with time. The activity points may increase by use of an item, etc. as well as with time. The activity point management table 52c in this example may manage activity points of users for all of the plurality of games provided by the system 10; alternatively, it may also be possible that, for example, each different table should manage activity points of users for only a corresponding game.

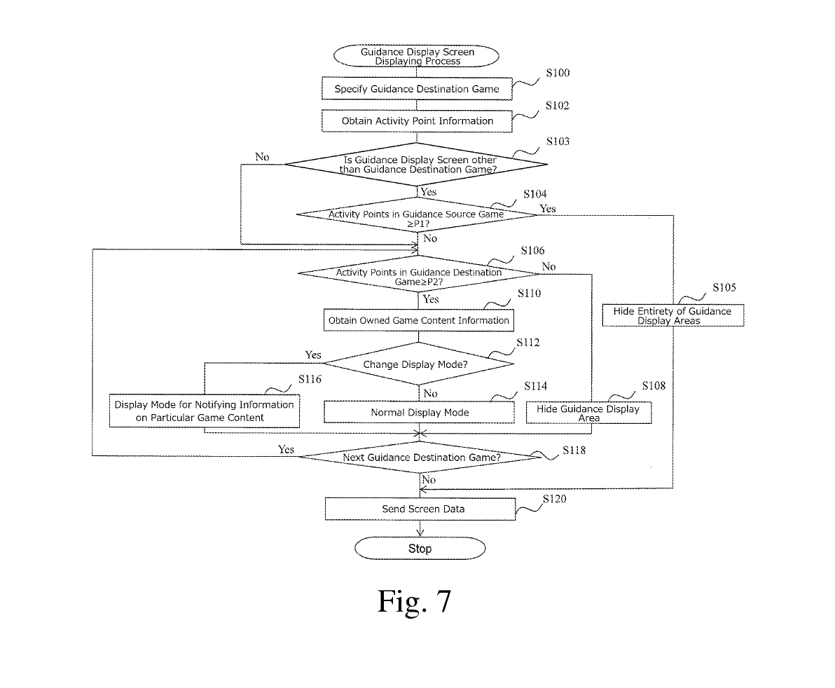

Next, operations of such a system 10 as an embodiment of the present invention will now be described. FIG. 7 is a flow diagram showing an example of a guidance display screen-displaying process performed by the system 10. The guidance display screen-displaying process may be performed when the system 10 receives, from a terminal device 30, a display request for a screen (guidance display screen) that can display a guidance display area for guiding a user to a screen (service-providing screen) for providing a guidance destination game; the screen (guidance display screen) may be used to provide a service other than the guidance destination game (including games other than the guidance destination game) or a platform. The service-providing screen of the guidance destination game to which the user is guided may be any of the screens for providing a guidance destination game; examples of such screens may include a top screen of the guidance destination game, My Menu screen from which the user may start playing the game, and a gacha screen (gasha screen) where to obtain a game content through a lottery. The guidance display screen that can display a guidance display area may be any of the screens used to provide the other services or platform; examples of such screens may include My Menu screen from which the user may start receiving the other services, a user profile screen of the platform, My Game screen where the user may select a game to be played from a plurality of games on the platform, a top screen of a game other than the guidance destination game, My Menu screen, a gasha screen, and an activity point deficiency screen displayed when the activity points are lacking for an instruction to perform a particular action in the other game.

As shown in FIG. 7, the first step of the guidance display screen-displaying process may be to specify guidance destination games to which the user operating the terminal device 30 having sent the display request for the guidance display screen is to be guided (step S100). One or more games may be specified as guidance destination games from a plurality of games that can be provided by the system 10 in accordance with the type of the guidance display screen. The rule for specifying the guidance destination game may be various. For example, the guidance destination game may be a game already played by the user, a game recommended by a service provider operating the platform, or a game specified by using an algorithm based on, e.g., action history of the user and recommended to the user.

The step after thus specifying one or more guidance destination games may be to obtain activity point information of the user (step S102). More specifically, the determination unit 53 may access the activity point management table 52c in the information storage unit 52 and obtain activity point information of the user operating the terminal device 30.

Subsequently, if the guidance display screen is a screen for providing a game other than the guidance destination game, the activity points in the other game (guidance source game) may be compared with a threshold value P1 based on the obtained activity point information of the user (steps S103 and S104); if the activity points in the guidance source game is equal to or larger than the threshold value P1, the system 10 may decide that the entirety of the guidance display areas in the guidance display screen should be hidden (not required to be displayed) (step S105), send to the terminal device 30 the screen data of the guidance display screen corresponding to the decided display mode (step S120), and then terminate the guidance display screen-displaying process. The values of the threshold value P1 may be various. For example, if the threshold value P1 is set to activity points required for a particular action (e.g., an action for advancing a mission by one unit, or a battle with an enemy character) in the guidance source game, users having activity points equal to or greater than the threshold value P1 can perform the particular action in the guidance source game; therefore, if a user can perform the particular action in the guidance source game, the system 10 may decide that the entirety of the guidance display areas should be hidden.

In contrast, if the guidance display screen is a screen for providing services other than games or a platform, or if the guidance display screen is a screen for providing a game (guidance source game) other than the guidance destination game and the activity points in the guidance source game are smaller than the threshold value P1, the system 10 may subsequently repeat a series of steps for deciding the display mode of the guidance display area (steps S106 to S118) for each of the one or more guidance destination games specified in step S100.

The process of deciding the display mode of the guidance display area related to the guidance destination game may include a step of comparing the activity points of the user in the guidance destination game with a threshold value P2 (step S106) and a subsequent step of deciding that the guidance display area related to the guidance destination game in the guidance display screen should be hidden if the activity points in the guidance destination game is smaller than the threshold value P2 (step S108). The values of the threshold value P2 may be various. For example, if the threshold value P2 is set to activity points required for a particular action (e.g., an action for advancing a mission by one unit, or a battle with an enemy character) in the guidance source game, users having activity points smaller than the threshold value P2 cannot perform the particular action in the guidance destination game; therefore, if a user cannot perform the particular action in the guidance destination game, the system 10 may decide that the guidance display area related to the guidance destination game should be hidden. If the user does not play the guidance destination game and does not have an activity point, the process may proceed to step S110 as in the case where the activity points are equal to or greater than the threshold value P2. This case will be described next.

If the activity points in the guidance destination game are equal to or greater than the threshold value P2, the system 10 may decide that the guidance display area related to the guidance destination game should be displayed (required to be displayed), and then obtain information on game contents owned by the user (step S110). More specifically, the determination unit 53 may access the game content management table 52a and the owned game content management table 52b of the information storage unit 52 to obtain information on game contents owned by the user operating the terminal device 30.

The next step may be to determine whether the player owns a game content that requires a change in display mode of the guidance display area (particular game content) among the game contents used in the guidance destination game, based on the obtained information on game contents owned by the user (step S112). As described above, the necessity of a change in display mode of the guidance display area may be preset for each game content, and can be determined by referring to the “display mode change necessity flag” in the game content management table 52a. In an embodiment, it can be determined that, for example, when the value of the “display mode change necessity flag” is “1,” a change in display mode of the guidance display area may be necessary, and when the value is “0,” the change may be unnecessary.

As a result of such determination, if the system 10 determines that the user does not own a particular game content used in the guidance destination game, the system 10 may decide that the display mode of the guidance display area should be a normal display mode (step S114); and if the system 10 determines that the user owns a particular game content used in the guidance destination game, the system 10 may decide that the display mode of the guidance display area should be a display mode for notifying the information on the particular game content (step S116).

The system 10 may thus perform the process of deciding the display mode of the guidance display area for each of all the guidance destination games (step S118), then send to the terminal device 30 the screen data of the guidance display screen corresponding to the decided display mode (step S120), and terminate the guidance display screen-displaying process.

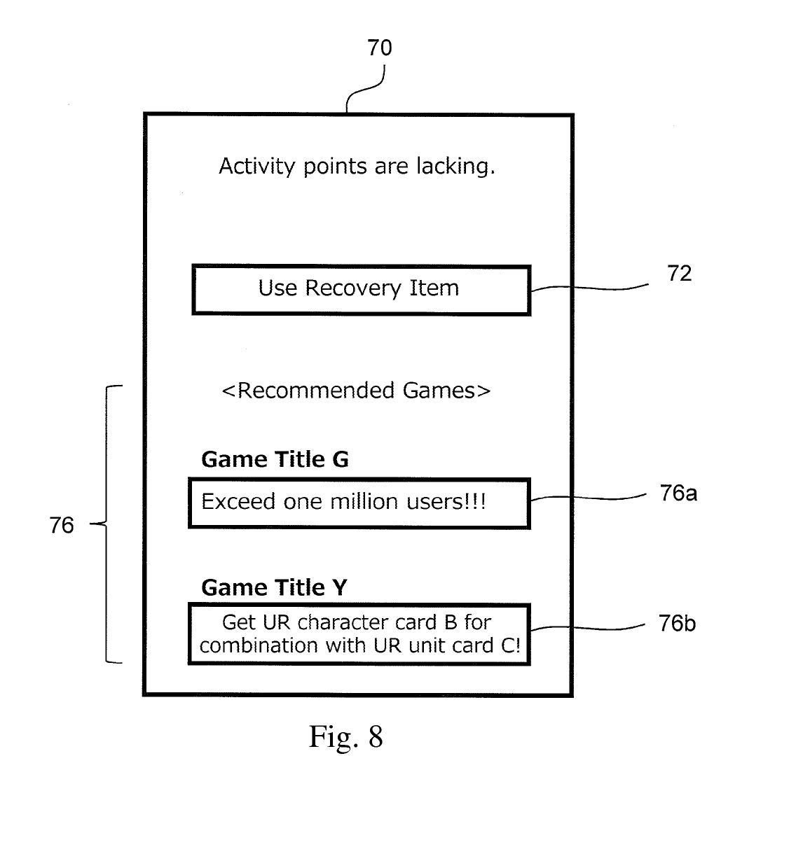

Various examples of guidance display screen displayed on the terminal device 30 by the guidance display screen-displaying process will be described with reference to the drawings. FIG. 8 shows an example of activity point deficiency screen 70 in a game other than the guidance destination game as an example of the guidance display screen. As described above, the activity point deficiency screen 70 may be displayed when the activity points are lacking for an instruction to perform a particular action. As shown, the activity point deficiency screen 70 may include: an item use instruction area 72 which may be disposed in the upper portion of the screen and may allow the user to make an instruction to use a recovery item for recovering activity points; and a recommended game display section 76 which may be disposed below the item use instruction area 72 and may display games to be recommended to the user (recommended games). When the user selects the item use instruction area 72, the screen transitions to a screen for using a recovery item or a screen for purchasing a recovery item, which may be displayed on the terminal device 30.

The recommended game display section 76 may include a guidance display area for each recommended game as a guidance destination game to which the user may be to be guided (76a, 76b). Each guidance display area may include a link to a service-providing screen of a corresponding guidance destination game; when the user selects a guidance display area, the corresponding service-providing screen may be displayed on the terminal device 30. In the example shown in FIG. 8, the guidance display area 76a is a guidance display area for guiding the user to the guidance destination game (game title G) in a normal display mode and is provided with an image containing the text “Exceed one million users!!!” Further, in the example shown in FIG. 8, the guidance display area 76b is a guidance display area for guiding the user to the guidance destination game (game title Y) in a display mode for notifying information related to a particular game content and is provided with an image containing the text “Get UR character card B for combination with UR unit card C!” This example represents the case where the user owns “UR unit card C,” which is a game content (card) used in the guidance destination game (game title Y) as a particular game content (recorded in the game content management table 52a as requiring a change in display mode); and the guidance display area may recommend the user to obtain “UR character B” for combination with “UR unit card C.” Such a display mode where information on a particular game content is notified may be implemented by, e.g., previously storing the images, etc. to be placed in the guidance display area on an appropriate region in the information storage unit 52 for each particular game content.

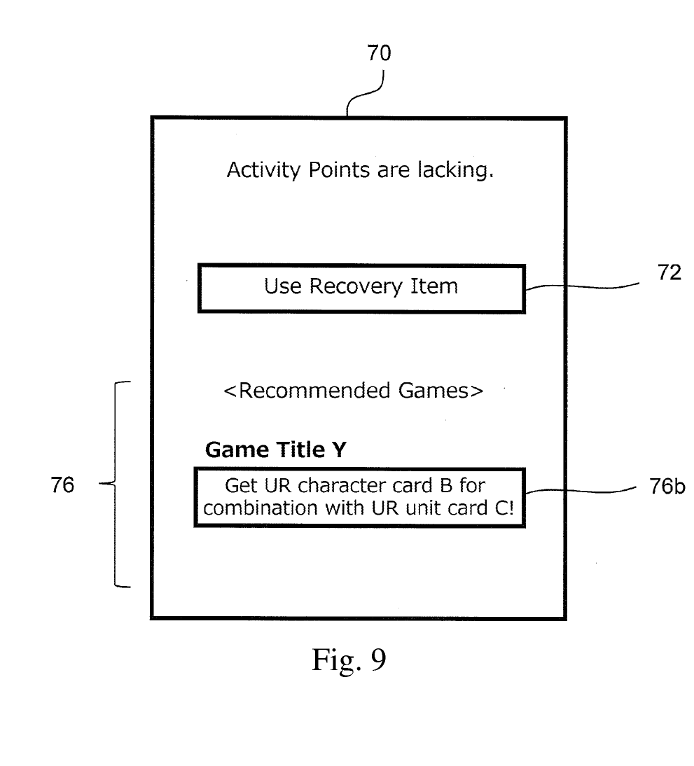

FIG. 9 shows an example of the activity point deficiency screen 70 of FIG. 8 displayed in the case where the activity points of the user in game title G are smaller than the threshold value P2. In this case, the guidance display area related to game title G, the guidance destination game, may be hidden; the recommended game display section 76 may only display a guidance display area 76b corresponding to game title Y (the guidance display area 76a related to game title G may not be displayed). If there is a guidance destination game for which the guidance display area is hidden, the system 10 may specify an additional guidance destination game and display a related guidance display area.

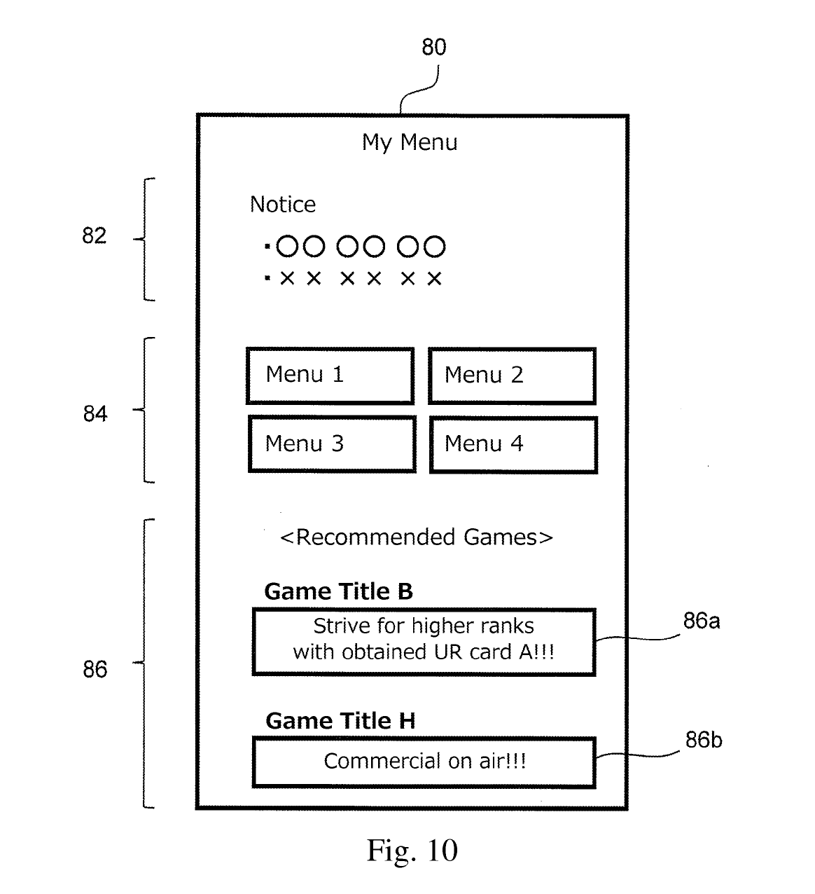

FIG. 10 shows an example of My Menu screen 80 in a game other than the guidance destination game as an example of the guidance display screen. As shown, My Menu screen 80 may contain a notification section 82 for displaying information to be notified to the user, a menu section 84 for the user to select an action menu for progressing the game, and a recommended game display section 86 for displaying games recommended to the user; and these sections are arranged in the order from the upper portion to the lower portion of the screen. As with the recommended game display section 76 in the activity point deficiency screen 70 shown in FIGS. 8 and 9, the recommended game display section 86 may contain guidance display areas (86a, 86b) each guiding the user to a corresponding recommended game as a guidance destination game. In the example shown in FIG. 10, the guidance display area 86a is a guidance display area for guiding the user to the guidance destination game (game title B) in a display mode for notifying information related to a particular game content and is provided with an image containing the text “Strive for higher ranks with obtained UR card A!!!” This example represents the case where the user owns a particular game content “UR card A,” which is a game content (card) used in the guidance destination game (game title B); this guidance display area notifies that “UR card A” enables the user to progress the guidance destination game advantageously. Further, in the example shown in FIG. 10, the guidance display area 86b is a guidance display area for guiding the user to the guidance destination game (game title H) in a normal display mode and is provided with an image containing the text “Commercial on air!!!”

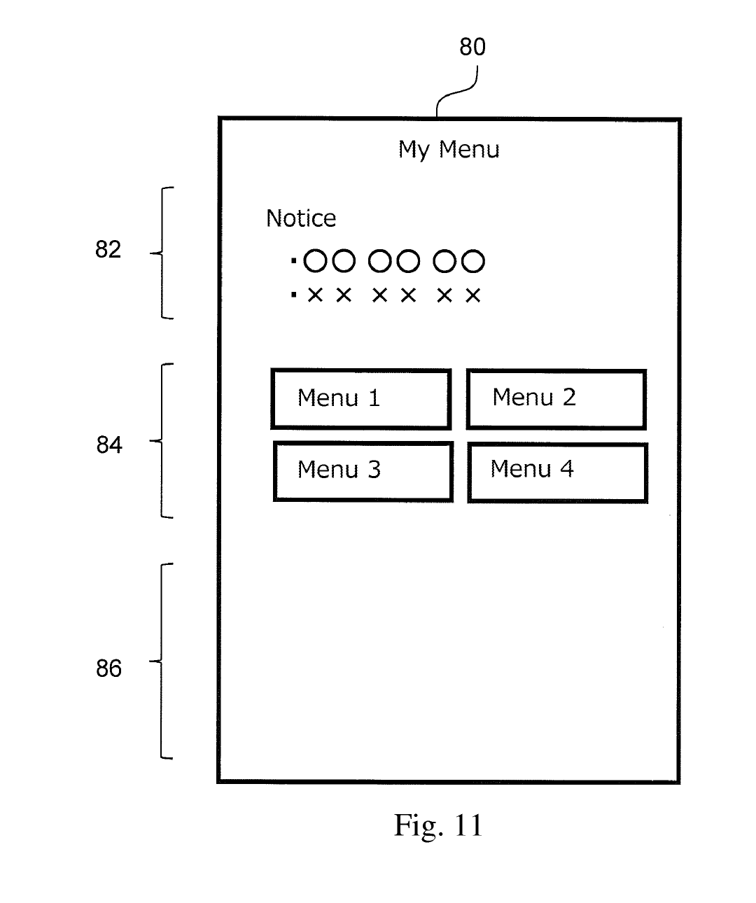

FIG. 11 shows an example of My Menu screen 80 shown in FIG. 10 in the case where the activity points in the game using My Menu screen 80 (a game other than the guidance destination game (a guidance source game)) is equal to or greater than the threshold value P1. In this case, the entirety of the guidance display areas is hidden; and the recommended game display section 86 displays nothing. When the entirety of the guidance display areas is hidden, the area corresponding to the recommended game display section 86 may display other information.

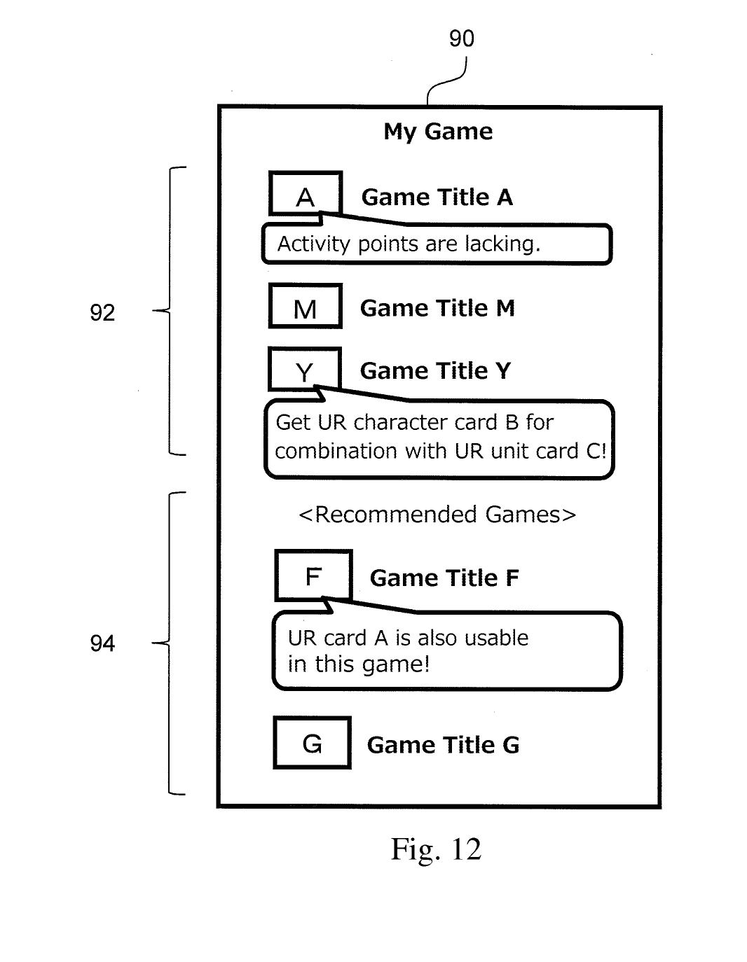

FIG. 12 shows an example of My Game screen 90 for providing a platform as an example of guidance display screen. As shown, My Game screen 90 may include a game list display section 92 for listing games already started by the user, and a recommended game display section 94 for displaying games recommended to the user. The game list display section 92 and the recommended game display section 94 may include game icons of the listed games in the left, and game titles on the right of the game icons. When the user selects a game icon or a game title, an application or browser installed on the terminal device 30 may be launched to start the selected game. That is, these game icons and game titles may correspond to guidance display areas for guiding the user to guidance destination games. The game title A in the game list display section 92 is a guidance display area in a display mode where the guidance display area should be hidden, and is provided with a balloon area extending from the game icon and containing the text “Activity points are lacking.” Thus, in an embodiment, the guidance display area displayed in the game list display section 92 in My Game screen 90 may not hide the game icons and game titles even in a display mode where the guidance display area should be hidden, and instead, may display the text such as “Activity points are lacking.” Alternatively, it may also be possible that, if a guidance display area displayed in the game list display section 92 of My Game screen 90 is in a display mode where the guidance display area should be hidden, the guidance display area should be hidden in accordance with the display mode. The game title M in the game list display section 92 is a guidance display area in a normal display mode; and the game title Y is a guidance display area in a display mode for notifying information on a particular game content. As shown, the game title Y in a display mode for notifying information on a particular game content is provided with the text “Get UR character card B for combination with UR unit card C!” in a balloon area extending from the game icon.

The game title F in the recommended game display section 94 of My Game screen 90 is a guidance display area in a display mode for notifying information on the particular game content and the game title G is a guidance display area in a normal display mode. As shown, the game title F in a display mode for notifying information on a particular game content is provided with the text “UR card A is also usable in this game!” in a balloon area extending from the game icon. This example represents the case where the user owns a particular game content “UR card A,” which is a game content (card) used in any of games already started by the user (e.g., game title Y); this guidance display area notifies that “UR card A” can also be used in the game title F, which is not yet started by the user.

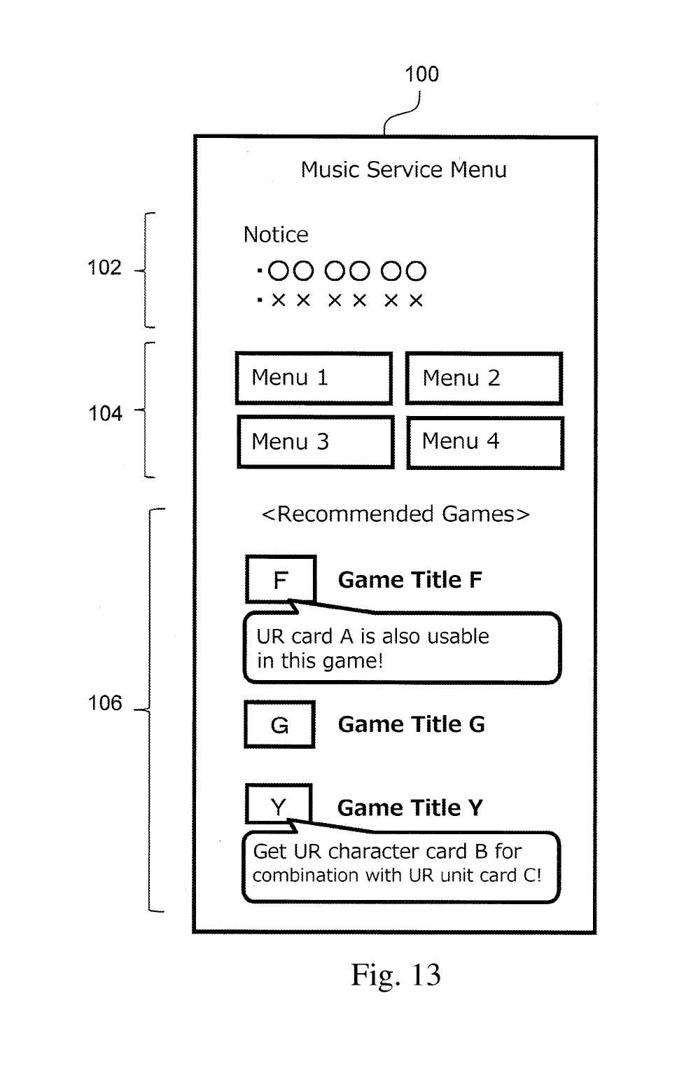

FIG. 13 shows an example of Music Service My Menu screen 100 for providing music services, which are services other than games, as an example of guidance display screen. As shown, Music Service My Menu screen 100 may contain a notification section 102 for displaying information on the music services to be notified to the user, a menu section 104 for the user to select an action menu for receiving the music services, and a recommended game display section 106 for displaying games recommended to the user; and these sections are arranged in the order from the upper portion to the lower portion of the screen. The recommended game display section 106 may include game icons of the listed recommended games in the left, and game titles on the right of the game icons. The recommended game display section 106 may be displayed in the same way as the recommended game display section 94 of My Game screen 90 shown in FIG. 12; therefore, further description on the recommended game display section 106 will be omitted. The screens shown in FIGS. 8 to 13 are mere examples; and the display modes of the guidance display areas are not limited to these examples. For example, it may also be possible that an image in a normal display mode should not include the text “Exceed one million users!!!” or “Commercial on air!!!”

The system 10 according to an embodiment described above can decide the display mode of a guidance display screen that can display a guidance display area for guiding the user to a service-providing screen of the guidance destination game and is used to provide services other than the guidance destination game or a platform, in accordance with whether the user owns a particular game content. Accordingly, the system 10 can change the display mode of the guidance display to a guidance destination game in accordance with the presence of the particular game content; the user may be guided to the guidance destination games more effectively. Further, when the user owns a particular game content, which is used in the guidance destination game, the display mode is changed so as to notify information on the particular game content; thus, the user may be guided to the guidance destination games more effectively.

Additionally, the system 10 according to an embodiment may decide the necessity of displaying the guidance display area in accordance with the comparison of the activity points (the first parameter) in the guidance destination game and the threshold value P2 (the first threshold value); therefore, when, e.g., the user cannot perform a particular action (the first action) in the guidance destination game, the guidance display area related to the guidance destination game may be hidden. As a result, less necessary guidance display to guidance destination games may be avoided; thus, the user may be guided to the guidance destination games more effectively. Additionally, the system 10 may decide the necessity of displaying the entirety of the guidance display areas in accordance with the comparison of the activity points (the second parameter) in the guidance source game and the threshold value P1 (the second threshold value); therefore, when, e.g., the user can perform a particular action (the second action) in the guidance source game, the entirety of the guidance display areas may be hidden. As a result, less necessary guidance display may be avoided; thus, the user may be guided to the guidance destination games more effectively.

In the case where the guidance display screen is a screen for providing a game other than the guidance destination game, the system 10 according to an embodiment may decide the necessity of displaying the entirety of the guidance display areas in the guidance display screen based on the comparison of the activity points in the other game (guidance source game) and the threshold value P1; alternatively, it may also be possible that the necessity of displaying the entirety of the guidance display areas should be decided based on information other than the activity points indicating the use status of the guidance source game. For example, it may be decided that display of the entirety of the guidance display areas is unnecessary when the number of days that have elapsed after the user started using the guidance source game is smaller than a threshold value; it may be decided that display of the entirety of the guidance display areas is unnecessary when the remaining time up to the time when a special event is started in the guidance source game is smaller than a threshold value; or it may be decided that display of the entirety of the guidance display areas is necessary when the duration of playing the guidance source game is larger than a threshold value. Further, it may also be possible that the entirety of the guidance display areas should always be displayed irrespective of the above use statuses of the guidance source game.

The system 10 according to an embodiment may decide the necessity of displaying the guidance display area related to the guidance destination game in the guidance display screen based on the comparison of the activity points in the guidance destination game and the threshold value P2; alternatively, it may also be possible that the necessity of displaying the guidance display area related to the guidance destination game should be decided based on information other than the activity points indicating the use status of the guidance destination game. For example, it may be decided that display of the guidance display area is necessary when the number of days that have elapsed after the user started using the guidance destination game is smaller than a threshold value; or it may be decided that display of the guidance display area is necessary when the remaining time up to the time when a special event is started in the guidance destination game is smaller than a threshold value. Further, it may also be possible that the guidance display area related to a guidance destination game specified as a guidance destination game should always be displayed irrespective of the above use statuses of the guidance destination game.

In the case where it is determined that the user owns a particular game content used in a guidance destination game, the system 10 according to an embodiment may decide that the guidance display area should be in the display mode for notifying information on the particular game content however, it is not necessary that the guidance display area should be in the display mode for notifying information on the particular game content; any display mode of the guidance display screen is possible as long as it is decided based on whether the user owns the particular game content. For example, a recommendation level for the guidance destination game displayed in a guidance display area may be higher when the user owns a particular game content than when the user does not own the particular game content. Further, it may also be possible to change the display mode of the guidance display area related to a guidance destination game (to a display mode different from the normal display mode) when the user owns a particular game content used in a game other than the guidance destination game.

In the system 10 according to an embodiment, the guidance display area of the guidance display screen may guide the user to a service-providing screen of the guidance destination game; alternatively, the guidance display area may guide the user to a service-providing screen for a service other than games. In this case, among electronic contents used in the other service, particular electronic contents may require change in display mode of the guidance display area; and such particular electronic contents may be managed by using tables corresponding to the game content management table 52a and the owned game content management table 52b in the embodiment. The electronic contents used in the other service may include a digital incentive used in SNS services, virtual currency used in music distribution services, and a stamp used in call/message exchange services. The display mode of the guidance display area related to a guidance destination service may be decided based on whether the user owns a particular electronic content among the above electronic contents.

The processes and procedures described and illustrated herein may also be implemented by software, hardware, or any combination thereof other than those explicitly stated for the embodiments. More specifically, the processes and procedures described and illustrated herein may be implemented by the installation of the logic corresponding to the processes into a medium such as an integrated circuit, a volatile memory, a non-volatile memory, a magnetic disk, or an optical storage. The processes and procedures described and illustrated herein may also be installed in the form of a computer program, and executed by various computers.

Even if the processes and the procedures described herein are executed by a single apparatus, software piece, component, or module, such processes and procedures may also be executed by a plurality of apparatuses, software pieces, components, and/or modules. Even if the data, tables, or databases described herein are stored in a single memory, such data, tables, or databases may also be dispersed and stored in a plurality of memories included in a single apparatus or in a plurality of memories dispersed and arranged in a plurality of apparatuses. The elements of the software and the hardware described herein can be integrated into fewer constituent elements or can be decomposed into more constituent elements.

With respect to the use of substantially any plural and/or singular terms herein, those having skill in the art can translate from the plural to the singular and/or from the singular to the plural as is appropriate to the context.

1. A system connected via a communication network to a plurality of terminal devices each operated by a user, the system being configured to provide a platform capable of providing a plurality of services to the user, the system comprising:
an information storage device configured to store, for each user, owned electronic content information on one or more electronic contents owned by the user and used in the services;
a determination unit configured to determine, in response to a request from one of the terminal devices, whether the user operating the terminal device owns a particular electronic content based on the owned electronic content information;
a decision unit configured to decide, based at least on a comparison result made by the determination unit, a display mode of a guidance display screen capable of displaying a guidance display area for guiding the user to a service-providing screen used for providing a particular service, the guidance display screen being used for providing the platform or a service other than the particular service; and
a display control unit configured to cause the terminal device to display the guidance display screen in the decided display mode,
wherein the particular electronic content is a particular game content used in a first game; and
the guidance display area guides the user to the service-providing screen for providing the first game.

2. (canceled)

3. The system of claim 1 wherein the decision unit decides whether display of the guidance display area is necessary based at least on use status of the first game by the user.

4. (canceled)

5. The system of claim 1 wherein the decision unit decides the display mode of the guidance display screen so as to notify information on the particular game content, in the case where the determination unit determines that the user owns the particular game content.

6. The system of claim 3 wherein
the information storage device stores, for each user, first parameter information on a first parameter used in the first game as one use status of the first game, in addition to the owned electronic content information, the first parameter reducing at least upon a first action and increasing at least with time;
the determination unit, determining whether the user owns the particular electronic content, also compares a value of the first parameter of the user operating the terminal device with a first threshold value based on the first parameter information; and
the decision unit decides that display of the guidance display area is necessary when the determination module determines that the value of the first parameter of the user is equal to or greater than the first threshold value, and decides that display of the guidance display area is unnecessary when the determination module determines that the value of the first parameter of the user is smaller than the first threshold value.

7. (canceled)

8. (canceled)

9. The system of claim 1 wherein the guidance display screen is capable of displaying a plurality of guidance display areas guiding the user to service-providing screens used for providing a plurality of respective particular services.

10. (canceled)

11. A method for a system to provide a platform capable of providing a plurality of services to a plurality of users each operating a terminal device connected to the system via a communication network, the method comprising the steps of:
storing, for each user, owned electronic content information on one or more electronic contents owned by the user and used in the services;
determining, in response to a request from the terminal device, whether the user operating the terminal device owns a particular electronic content based on the owned electronic content information;
deciding, based at least on a result of the comparison, a display mode of a guidance display screen capable of displaying a guidance display area for guiding the user to a service-providing screen used for providing a particular service, the guidance display screen being used for providing the platform or a service other than the particular service; and
causing the terminal device to display the guidance display screen in the decided display mode,
wherein the particular electronic content is a particular game content used in a first game; and
the guidance display area guides the user to the service-providing screen for providing the first game.

12. A system connected via a communication network to a plurality of terminal devices each operated by a user, the system being configured to provide a platform capable of providing a plurality of services to the user, the system comprising:
an information storage unit configured to store, for each user, owned electronic content information on one or more electronic contents owned by the user and used in the services;
a determination unit configured to determine, in response to a request from the terminal device, whether the user operating the terminal device owns a particular electronic content based on the owned electronic content information;
a decision unit configured to decide, based at least on a comparison result made by the determination unit, a display mode of a guidance display screen capable of displaying a guidance display area for guiding the user to a service-providing screen used for providing a particular service, the guidance display screen being used for providing a service other than the particular service; and
a display control unit configured to cause the terminal device to display the guidance display screen in the decided display mode,
wherein the decision unit decides whether display of the guidance display area is necessary based at least on use status of the other service by the user.

13. The system of claim 12 wherein the particular electronic content is used in the particular service.

14. The system of claim 12 wherein
the other service is a second game;
the information storage device stores, for each user, second parameter information on a second parameter used in the second game as one use status of the second game, in addition to the owned electronic content information, the second parameter reducing at least upon a second action and increasing at least with time;
the determination module, determining whether the user owns the particular electronic content, also compares a value of the second parameter of the user operating the terminal device with a second threshold value based on the second parameter information; and
the decision module decides that display of the guidance display area is unnecessary when the determination module determines that the value of the second parameter of the user is equal to or greater than the second threshold value, and decides that display of the guidance display area is necessary when the determination module determines that the value of the second parameter of the user is smaller than the second threshold value.

15. The system of claim 12 wherein the guidance display screen is capable of displaying a plurality of guidance display areas guiding the user to service-providing screens used for providing a plurality of respective particular services.
